(19) United States
(12) Patent Application Publication
(10) Pub. No.: US 2019/0012611 A1
(43) Pub. Date: Jan. 10, 2019

(54) INFORMATION PROCESSING SYSTEM

(71) Applicant: Hitachi, Ltd., Tokyo (JP)

(72) Inventors: Tadayuki MATSUMURA, Tokyo (JP); Atsushi MIYAMOTO, Tokyo (JP)

(21) Appl. No.: 16/008,128

(22) Filed: Jun. 14, 2018

(30) Foreign Application Priority Data
Jul. 4, 2017 (JP) 2017-130811

(51) Int. Cl. G06N 99/00; G06N 5/04

(52) U.S. Cl. CPC G06N 99/005; G06N 5/046

(57) ABSTRACT

An information processing system includes a learning model unit, a trainer unit for allowing the learning model unit to learn, and a storage unit. The storage unit stores a validation rule defined in advance that indicates a condition determining that an output value of the learning model unit for an input value is true. The trainer unit inputs a plurality of input values to the learning model unit, obtains a plurality of output values of the learning model unit for the plurality of input values, determines whether each of the output values is true for each of the input values by referring to the validation rule, and stores a pair of an output data, which is determined to be true in the plurality of output values, and the corresponding input value into the storage unit, as new training data for supervised learning.

### CROSS-REFERENCE TO RELATED APPLICATION

This application claims priority to Japanese Patent Application No. 2017-130811 filed on Jul. 4, 2017, the entire contents of which are incorporated by reference herein.

### TECHNICAL FIELD

The present invention relates to a technique for generating training data of machine learning.

### BACKGROUND ART

Along with the increasing cost of system development and the advanced machine learning requirement specification as well as the increasing uncertainty, there has been an increase in system development cost. Under such circumstances, there has been an accelerating trend in loading a module that retunes an output y for an input x, (y=f(x)), into a series of program development flows as a predictive model of machine leaning (Machine Learning as Programming), instead of programming by hand.

Particularly, in the technique of artificial neural network (ANN) that has been successful in image processing application, successes (DNC: Differential Neural Computer, NPI: Neural program interpreter, and the like) have started to be reported also in learning of algorithms for sequence data and structural data. It is expected that this flow will be applied not only to the conventional image processing application but also to a wider range of applications in the future.

Machine learning models including ANN require massive and comprehensive teacher data. For example, US Patent No. 2011/0167027 (Patent Literature 1) discloses a technique for sorting and weighting the externally input training data according to a rule. More specifically, an information analysis device includes: a density estimation unit for estimating the density that indicates the percentage of target information included in unit of analysis, with respect to each analysis unit of a plurality of texts of text information; and a determination unit for obtaining the evaluation value that indicates the percentage of each text included in each analysis unit, corresponding to the target information, from the predictive density of the analysis unit, and determining whether or not the information corresponds to the target information based on the evaluation value.

### CITATION LIST

### Patent Literature

Patent Literature 1: US2011/0167027A1

### SUMMARY OF INVENTION

### Technical Problem

As described above, the machine learning model requires massive and comprehensive teacher data. However, the model (algorithm) that has not completed the required learning is basically not able to generate accurate teacher data. The fact that the model is able to generate accurate teacher data means that the learning required for the model has been completed.

The technique disclosed in Patent Literature 1 can sort and weight training data from the externally input data, however, may not automatically generate teacher data that can be used in machine learning.

Therefore, it is desirable to develop a technique that can automatically generate teacher data for machine learning by a device.

### Solution to Problem

An aspect of the present invention is an information processing system including a leaning model unit, a trainer unit that allows the learning model unit to lean, and a storage unit. The storage unit stores a predefined validation rule that indicates a condition determining that an output value of the learning model for an input value is true. The trainer unit inputs a plurality of first input values to the learning model unit, obtains a plurality of first output values of the leaning model unit for the plurality of first input values, determines whether each of the first output values is true for each of the first input values by referring to the validation rule, and stores a pair of the first output value, which is determined to be true in the plurality of first output values, and the corresponding first input value into the storage unit, as new training data for supervised learning.

### Advantageous Effects of Invention

According to an aspect of the present invention, it is possible to automatically generate teacher data for machine learning by a device.

### BRIEF DESCRIPTION OF DRAWINGS

FIG. 1 shows a configuration example of an information processing system according to the embodiment.

FIG. 2 shows a configuration example of a computer.

FIG. 3 shows a flow chart of a process in which a self-trainer unit allows a learning model unit to learn.

FIG. 4A shows an example of the information included in a self-training rule for sorting problem.

FIG. 4B shows an example of a validation rule.

FIG. 5A shows an example of an input network to the learning model unit.

FIG. 5B shows an example of an output flow from the learning model unit, in which the number of an edge indicates the flow rate.

FIG. 5C shows a residual network generated from the input network and the output flow.

FIG. 5D shows a residual network obtained by removing the edges with directions (solid line arrows) whose residual capacity is zero, from the residual network shown in FIG. 5C.

FIG. 6 shows an example of the input network to the learning model unit.

FIG. 7A shows four roads connected to one intersection to illustrate the flow conservation law.

FIG. 7B shows the four roads connected to one intersection to illustrate the flow conservation law.

FIG. 8 shows another configuration example of the information processing system 1 that is applied to on-site crowd control.

FIG. 9A shows the result when learning with sequence length 5 is completed in the evaluation for the ECHO problem of the machine learning system according to the present embodiment.

FIG. 9B shows the intermediate result of learning with sequence length 6 in the evaluation for the ECHO problem of the machine learning system according to the present embodiment.

FIG. 9C shows the result when the learning with sequence length 6 is completed in the evaluation for the ECHO problem of the machine learning system according to the present embodiment.

FIG. 9D shows the result when learning with sequence length 10 is completed in the evaluation for the ECHO problem of the machine learning system according to the present embodiment.

FIG. 9E shows the result when learning with sequence length 19 is completed in the evaluation for the ECHO problem of the machine learning system according to the present embodiment.

### DESCRIPTION OF EMBODIMENTS

Hereinafter, an embodiment of the present invention will be described with reference to the accompanying drawings. It is to be noted that the present embodiment is only an example that implements the present invention and is not intended to limit the scope of the present invention. Like reference numerals denote like or corresponding components throughout the drawings.

An information processing system according to an embodiment disclosed below automatically generates teacher data used in machine learning. The information processing system generates teacher data by using a model of machine learning. The model (algorithm) obtained by machine learning is basically a fitting model for given data that can properly react to an input in the vicinity of a learning sample, in which the generalization/extrapolation is low for unknown input data.

On the other hand, system designers of machine learning already have declarative knowledge in programming (generation of procedural knowledge). In other words, even without having the procedural knowledge (model) for solving the target problem, the system designer already has the declarative knowledge of the target problem. For example, in the example of the problem of sorting a sequence of numbers, the system designer can determine whether the result of changing the order of the sequence is the correct sorting result, even without having the procedural knowledge (model) for obtaining the correct sorting result. For example, the system designer can determine whether the output (answer) [1, 2, 3] is the intended result for the input [1, 3, 2].

In the information processing system of the present disclosure, a validation rule is defined in advance to determine whether or not the output of a model is the correct answer. The validation rule indicates the condition under which the output (answer) should be the correct answer for the input. The system designer defines in advance the validation rule to the information processing system based on the declarative knowledge of the problem that the model intends to solve.

The information processing system inputs test data for which the correct answer is unknown into the model, and obtains the output. The information processing system holds pair (samples) of inputs and outputs as teacher data candidates. The information processing system determines whether or not the output of each of the pairs, which are teacher data candidates, is the correct answer. The information processing system stores a pair whose output is the correct answer, as new teacher data.

As described above, the information system can autonomously generate teacher data by generating teacher candidate data by using the learning model, and by selecting teacher data from the teacher candidate data based on the validation rule.

Further, the information processing system allows the model to learn by using the newly generated teacher data. In this way, the information processing system can autonomously repeat generating teacher data and performing supervised learning of the model.

For example, the information processing system allows the model to learn a simple task. The teacher data of the simple task is, for example, prepared by the system designer in advance. The simple task is a task with low computational complexity in the computational theory. For example, in a sorting problem, the greater the number of elements of a number sequence, the higher the difficulty of the task. There are different tasks of the same problem, and tasks of different problems are different tasks.

In this way, it is possible to effectively generate teacher data by generating teacher data of a more difficult task by using the model after learning with a simple task. Teacher data generated by a certain model can be used for the learning of the particular model (model of the same problem), and can also be used for a model (model of a different problem) that is different from the particular model.

By repeating the supervised learning of model and the generation of new teacher data, the information processing system can autonomously proceed with the supervised learning of model, without preparing a large amount of teacher data. When the system designer gives simple teacher data, the information processing system can be applied to more complex tasks by autonomously repeating generation of training data (teacher data) and relearning.

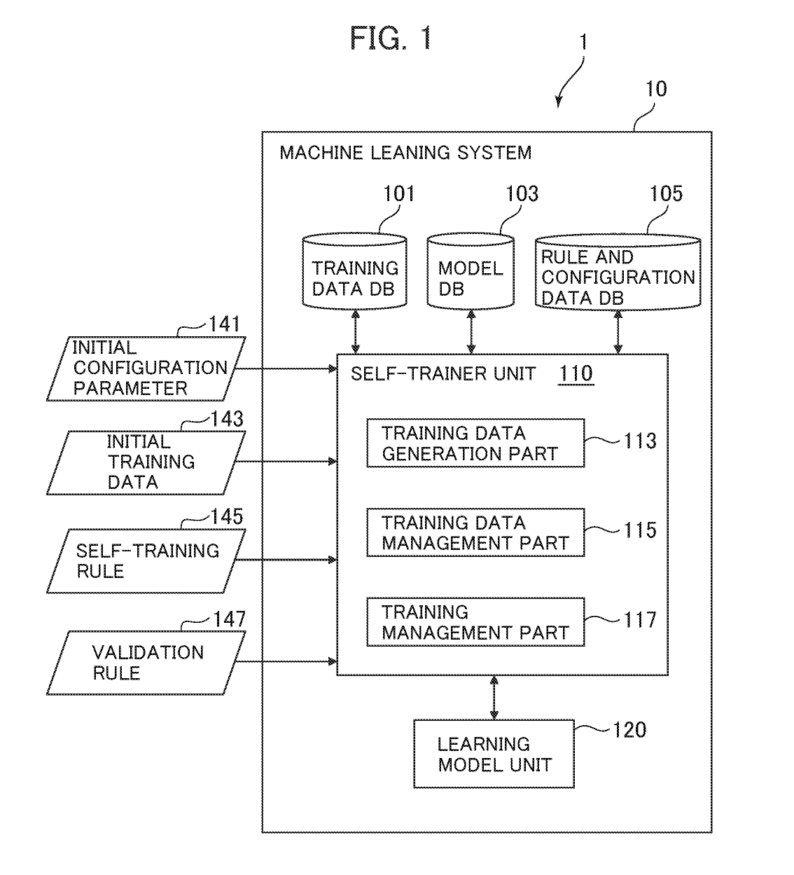

FIG. 1 shows a configuration example of an information processing system 1 according to the present embodiment. The information processing system 1 includes a machine learning system 10. The machine learning system 10 includes a self-trainer unit 110, control data that the self-trainer unit 110 uses, a learning model unit (also simply referred to as a model) 120, and training data (also referred to as learning data) used for the learning of the learning model unit 120. The training data is teacher data for supervised learning. Each sample of the teacher data is configured with a pair of an input value (input data) and an output value (output data).

The learning model unit 120 can be an arbitrary model of supervised learning. The self-trainer unit 110 can allow the learning model unit 120 of an arbitrary model type to learn, including, for example, a decision tree, a support vector machine, a deep neural network (deep learning), a logistic regression, and the like.

The self-trainer unit 110 allows the learning model unit 120 to learn so as to be able to solve the target problem, by using the teacher data. The self-trainer unit 110 includes a training data generation part 113, a training data management part 115, and a training management part 117.

The self-trainer unit 110 receives an input of initial data. The initial data includes initial control data including an initial configuration parameter 141, a self-training rule 145, and a validation rule 147, as well as initial training data 143. The training management part 117 receives the input of the initial control data and stores in a rule and configuration data database (DB) 105. The training data management part 115 stores the input initial training data 143 into the training data DB 101.

The initial configuration parameter 141 includes a configuration parameter that is referred to in the learning of the learning model unit 120. The initial configuration parameter 141 includes, for example, a loss function, an optimization approach (for example, a specific algorithm of the gradient descent method), and an optimization parameter. The self-trainer unit 110 updates the optimization parameter based on the value of the loss function for the difference between the output of the learning model unit 120 and the correct answer, according to the specified optimization method in the supervised learning of the learning model unit 120.

The self-training rule 145 indicates the rule about teacher data generation and learning task for the learning of the learning model unit 120. The self-trainer unit 110 generates new teacher data by using the learning model unit 120 according to the self-training rule 145, and performs relearning of the learning model unit 120 by using the generated teacher data. The information of the learning model unit 120 before relearning is stored in the model DB 103.

More specifically, the self-training rule 145 establishes the procedure for generating new input data in order to generate candidates of teacher data for the next learning task, the end determination condition of the learning task, and the procedure for updating the content of the learning task. The self-trainer unit 110 generates new teacher data by using the learning model unit 120 for a new learning task.

The validation rule 147 indicates the method (criteria) for determining whether or not the output for an input to the learning model unit 120 is the correct answer. Based on the validation rule 147, the self-trainer unit 110 can select the correct teacher data from the teacher data candidates that the learning model unit 120 generated.

Of the teacher data candidate samples that the learning model unit 120 generated, the self-trainer unit 110 selects the sample whose output value for the input value is the correct answer, according to the validation ruled 147. As described above, the system designer defines and generates the validation rule 147 based on the declarative knowledge and sets in advance in the information processing system 1.

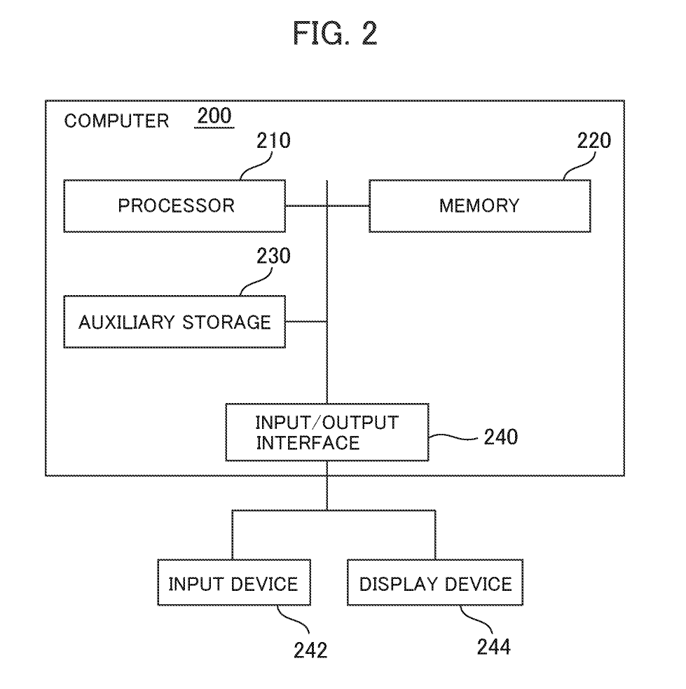

For example, the machine learning system 10 can be configured with a computer system including one or a plurality of computers in which predetermined programs and data are installed. FIG. 2 shows a configuration example of a computer 200. The computer 200 includes a processor 210, a memory 220, an auxiliary storage 230, and an input/output interface 240. The above components are connected to each other by a bus. The memory 220, the auxiliary storage 230 or combination thereof are examples of storage units.

The memory 220 is, for example, configured with a semiconductor memory and is mainly used to temporarily hold programs and data. The memory 220 stores programs for configuring the self-trainer unit 110 and the learning model unit 120.

The processor 210 performs various processes according to the programs stored in the memory 220. Various functional parts can be achieved by operation of the processor 210 according to the programs. For example, the processor 210 operates as the self-trainer unit 110 and the learning model unit 120 according to the respective programs.

The auxiliary storage 230 is, for example, configured with a large capacity storage unit such as a hard disk drive or a solid state drive, and is used for holding programs and data for a long time. In the present embodiment, the auxiliary storage 230 stores a training data DB 101, a mode DB 103, and a rule and configuration data DB 105.

The programs stored in the auxiliary storage 230 are loaded into the memory 220, respectively, at the time of startup or when needed. Then, the processor 210 executes the respective programs to perform various processes of the machine learning system 10. Thus, the processes performed by the programs are processes by the processor 210 or the machine learning system 10.

The input/output interface 240 is an interface for connection with peripheral devices. For example, an input device 242 and a display device 244 are connected to the input/output interface 240. The input device 242 is a hardware device by which the user inputs instructions and information to a text generation device 100. The display device 244 is a hardware device that displays various images to be input and output.

The machine learning system 10 has learning mode and operation mode (process mode) for the learning model unit 120. In the operation mode, the learning model unit 120 generates output data for input data (for example, measurement data). The output data is transmitted to a predetermined device.

In the learning mode, the self-trainer unit 110 generates training data (teacher data) by the learning model unit 120 as described above. Then, the self-trainer unit 110 allows the learning model 120 to learn by using the generated training data. The learning mode includes learning phase and test phase. The learning phase inputs the training data to the learning model unit 120 to update the optimization parameters of the training data. The test phase inputs the test data (teacher data) to the learning model unit 120 to verify the degree of learning of the learning model unit 120 by comparing the output to the correct answer.

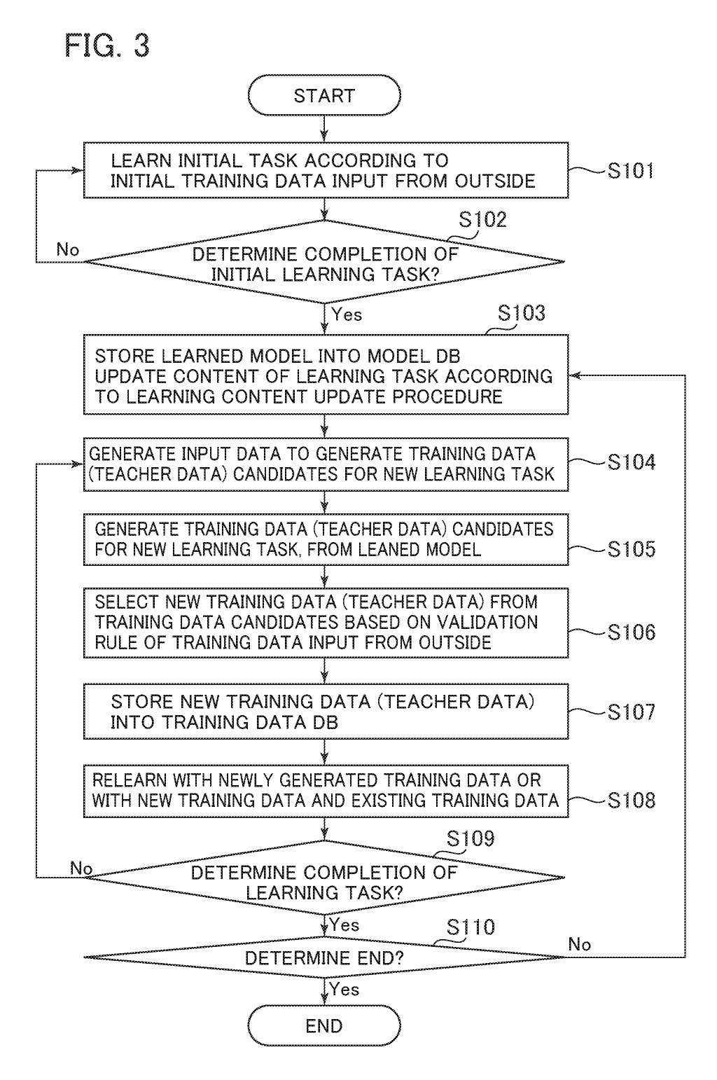

In the following, a description will be given of the process in which the self-trainer unit 110 allows the learning model unit 120 to learn, by referring to a flow chart of FIG. 3. First, the training data management part 115 of the self-trainer unit 110 obtains an externally input initial training data 143 from the training data DB 101. The training management part 117 inputs the initial training data 143 into the learning model unit 120, and allows the learning model unit 120 to learn the initial learning task based on the initial configuration parameter 141 (S101). The learning method of the learning model unit 120 is widely known, so that the description thereof will be omitted.

The training management part 117 determines whether or not the initial learning task is completed based on the learning end determination condition indicated by the self-training rule 145 (S102). When the initial learning task is not completed (S102: NO), the training management part 117 returns to Step S101 and restarts the initial learning task.

When the initial learning task is completed (S102: YES), the training management part 117 generates a copy of the learned model (data including the program of the learning model unit) and stores in the model DB 103. Further, the training management part 117 updates the content of the learning task according to the learning content update procedure established by the self-training rule 145 (S103). For example, the learning task is updated to content with higher computational complexity.

The training data generation part 113 generates input data to generate training data (teacher data) candidates for a new learning task (S104). The training data generation part 113 generates input data corresponding to the content of the updated learning task.

The training data generation part 113 generates training data (teacher data) candidates for the new learning task, from the newly generated input data, by the learning model unit 120 after learning (S105).

The training data generation part 113 selects new training data (teacher data) from the generated training data candidates based on the validation rule 147 of the externally input training data (S106). The training data generation part 113 determines whether or not the output is the correct answer, based on the validation rule 147, with respect to all the generated training data candidate samples.

The training data generation part 113 includes all the samples (pairs of inputs and outputs) including the output which is the correct answer, into the new training data (teacher data). The training data management part 115 stores the new training data (teacher data) into the training data DB 101 (S107).

The training management part 117 performs relearning of the learning model unit 120 by using the newly generated training data or by using both the new training data and the existing training data, based on the initial configuration parameter 141 (S108). As described above, the learning method using the training data is a known technique, and thus the description thereof is omitted.

The training management part 117 determines whether or not the current learning task is completed based on the learning end determination condition indicated by the self-training rule 145 (S109). In this way, it is possible to proceed to the next learning task appropriately. For example, the training management part 117 inputs the test data into the learning model unit 120 to determine whether or not to end the learning task of the current learning content based on the accuracy rate. For example, when the accuracy rate to a predetermined input number is equal to or more than a predetermined value, it is determined to complete the learning task.

When the current learning task is not completed (S109: NO), the training management part 117 returns to Step S104. The training data generation part 113 generates input data to generate new training data candidates (S104). The generated input data is for the same learning task as that of the last generated input data (the content is the same).

The training data generation part 113 generates new training data candidates by using the learning model currently learning, or by using the last learned model stored in the model DB 103 (S105). The training data generation part 113 generates new training data not included in the existing training data. The training management part 117 generates, for example, input data not included in the existing training data to generate training data candidates. When there are a plurality of output values considered to be the correct answer for the same input value, the input data included in the existing training data can be used for training data candidate generation.

The training data generation part 113 selects new training data (teacher data) from the generated training data candidates based on the validation rule 147 of the externally input training data (S106). The training data management part 115 stores the new training data (teacher data) into the training data DB 101 (S107). The training management part 117 performs relearning of the learning model unit 120 by using the newly generated training data (S108).

When the current learning task is completed (S109: YES), the training management part 117 determines whether or not to end the learning of the learning model unit 120 based on the learning end condition indicated by the self-training rule 145 (S110). If it is determined to continue the learning (S110: NO), the training management part 117 returns to Step S103 to store the learning model after learning into the model DB 103. Then, the training management part 117 updates the content of the learning task and restarts the learning task.

The above example uses the new training data that the learning model unit 120 generated for the relearning of the learning model unit 120. The new training data can be used for the learning of learning models other than the learning model unit 120. For example, the training data generated by a learning model that is intended to solve a particular problem can be used for the learning of a learning model that are intended to solve another problem.

The above example performs the learning of the learning model unit 120 by using the externally input initial training data. It is possible to efficiently generate new training data by the learning model unit after learning. Unlike this, it may be possible to omit the learning by the initial training data by using the learning model unit 120 that has learned in advance by the initial training data. The learning by the externally input initial training data eliminates the need to prepare the learning model unit 120 after learning.

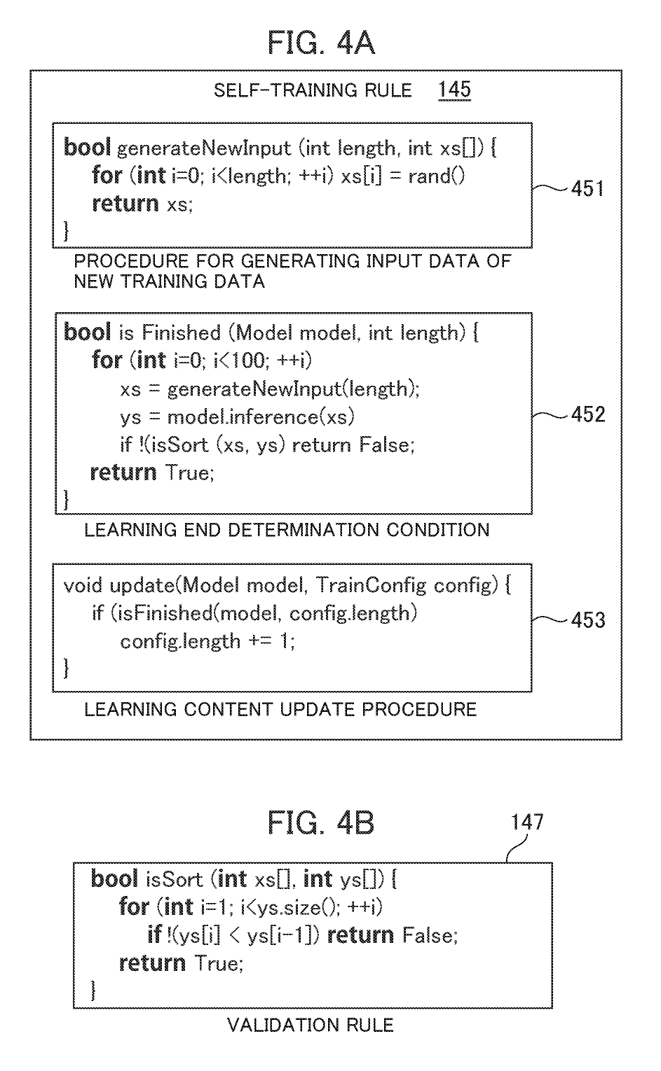

In the following, the learning of the learning model unit 120 will be described taking the sorting problem as an example. The sorting problem rearranges an input sequence of numbers in descending or ascending order. FIG. 4A shows an example of the information included in the self-training rule 145 for the sorting problem. The self-training rule 145 establishes a procedure 451 for generating input data of new training data, a learning end determination condition 452, and a leaning content update procedure 453. FIG. 4B shows an example of the validation rule 147.

In the present example, the sorting order is an ascending order. The procedure 451 for generating input data of new training data represents a function for generating new input data x. The function returns a random number sequence with a predetermined length “length”.

The validation rule 147 establishes that the element sets of input data xs and output data ys are equal and the magnitude relation between all adjacent elements is appropriate. The appropriate magnitude relation in ascending order is that the value of the next element is equal to or more than the value of the previous element.

The leaning end determination condition 452 establishes that test data samples of a predetermined random number are the correct answer (accuracy rate 100%). The predetermined number in this example is 100. The learning content update procedure 453 shows that the length of the sequence is updated and returned at the time of the completion of learning task. This example increments the length of the sequence.

An example of the method of leaning the sorting problem will be described. The training data management part 115 obtains the initial training data 143 from the training data DB 101. The initial training data 143 is teacher data with a sequence of a predetermined number of elements, for example, five elements.

The training management part 117 allows the learning model unit 120 to learn with the initial training data 143 (S101). Then, the training management part 117 tests the learning model unit 120 by randomly generating input samples with elements 100 which is the same as the number of elements of the initial training data 143. The training management part 117 determines whether or not the output is the correct answer based on the validation rule 147. When the learning mode unit 120 outputs the correct answer for all samples, the initial learning task is completed (S102: YES).

The training management part 117 stores a copy of the learning model after learning into the model DB 103. The training management part 117 updates the content of the learning task according to the learning content update procedure 453 (S103). The training management part 117 increments the “length” of the procedure 451 for generating input data of new training data. The initial value of the “length” corresponds to the number of elements of the initial training data 143.

The training data generation part 113 generates a random number sequence with the “length” of the predetermined number according to the procedure 451 for generating input data of new training data (S104). The random number sequence is input data for generating teacher data candidates. The length “length” is, for example, 6.

The training data generation part 113 inputs the generated random number sequences into the learning model unit 120 after learning to obtain their respective output values (sequences) (S105). Pairs of random number sequences and output values are candidates for the training data sample.

The training data generation part 113 selects new training data (teacher data) samples from the generated training data sample candidates based on the validation rule 147 (S106). In each sample selected as training data, the elements of the output number sequence correspond to the elements of the input random number sequence, and at the same time, the value of the next element is equal to or more than the value of the previous element between all adjacent elements in the output number sequence. The training data management part 115 stores the new training data into the training data DB 101 (S107).

The training management part 117 performs relearning of the learning model unit 120 by only the newly generated training data with number of elements 6, or by the existing training data (initial training data) with number of elements 5 as well as the new training data with number of elements 6 (S108). The training data with number of elements 6 is the data whose computational complexity is higher than that of the training data with number of elements 5.

Then, the training management part 117 determines whether the current learning task has been completed based on the learning end determination condition indicted by the self-training rule 145 (S109). For example, the training management part 117 repeatedly generates random number sequences with number of elements 5 or 6, to generate in total 100 input random number sequences for test. The number of elements of each random number sequence is, for example, determined at random. The training management part 117 inputs 100 input random number sequences into the learning model unit 120. Then, the training management part 117 determines whether each of the outputs is the correct answer according to the validation rule 147. Only the random number sequence with number of elements 6 can be generated depending on the learning method.

When all the outputs from the learning model unit 120 are the correct answer (S109: YES), the learning task is completed. When the learning of the learning model unit 120 should be continued (S110: NO), the training management part 117 stores a copy of the learning model after learning into the model DB 103, and increments the length “length” (S103). Then the training management part 117 performs generation of new training data for the next learning task as well as leaning (relearning) of the learning model unit 120 (S104 to 109).

If any of the outputs is a wrong answer (S109: NO), the training data generation part 113 generates new training data with number of elements 6 by using the learning model unit 120 (S105). The training management part 117 performs relearning of the learning model unit 120 by using the newly generated training data with number of elements 6 (S106 to S109).

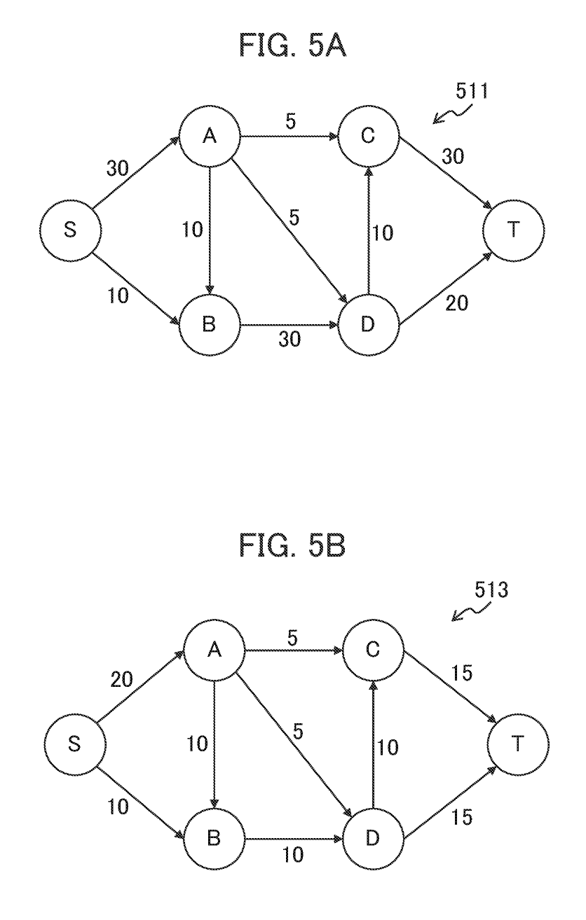

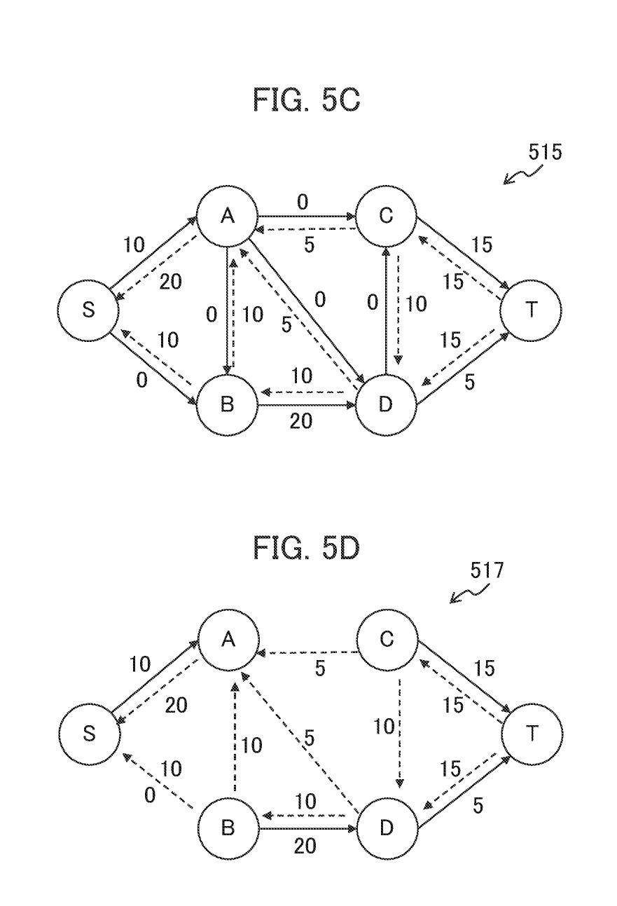

Next, an example of maximum flow problem will be described. The maximum flow problem is the problem of obtaining the maximum amount of flow from a source to a sink in a graph with capacities. FIGS. 5A to 5D schematically show the maximum flow problem and its solution.

FIG. 5A shows an example 511 of input network to the learning model unit 120. The S node represents the source and the T node represents the sink. The arrows of edges indicate the direction of flow, and the numbers on the edges indicate the capacity. FIG. 5B shows an example 513 of output flow from the learning model unit 120. The numbers on the edges indicate the flow rate.

FIG. 5C shows a residual network 515 that is generated by the input network 511 and the output flow 513. The number of each solid line arrow (edge) indicates the value obtained by subtracting the flow rate of the output flow 513 from the capacity of the input network 511, which shows another possible flow rate in the edge. The number of each dashed line arrow indicates the flow rate that can flow in the edge in the opposite direction. The number of each dashed line arrow corresponds to the flow rate of the edge in the output flow 513.

FIG. 5D shows a residual network 517 obtained by removing directed edges (solid line arrows) with residual capacity 0 from the residual network 515 shown in FIG. 5C. The residual network 515 and the residual network 517 are different expressions of the same residual network. There is no path from the S node to the T node in the residual network 517 shown in FIG. 5D. The path is configured with directed edges (solid line arrows and dashed line arrows) that remain in the residual network 517.

The absence of the path from the S node to the T node in the residual network 517 means that the output flow 513 shows the maximum flow from the S node to the T node. Thus, the absence of the path from the S node to the T node in the residual network can be used as the validation rule 147 of the maximum flow problem.

In the following, a description will be given of an example of the self-training rule 145 and the validation rule 147 for the maximum flow problem. As described above, the self-training rule 145 establishes the procedure for generating input data of new training data, the learning end determination condition, and the learning content update procedure.

The procedure for generating input data of new training data instructs to generate a predetermined number of graphs with different configurations, from a predetermined number of nodes and a predetermined number of edges. The procedure for generating input data of new training data also instructs to generate a predetermined number of networks with combinations of different capacities, from each graph. For example, a random number in a given range is assigned to the flow rate of each edge.

The procedure for generating input data of new training data establishes the maximum number of edges connected to one node. The graph includes edges connecting between nodes and does not establish the capacity for edges or nodes. The edges can have a direction. Here, the graph establishes a source node and a sink node, which also includes paths from the source node to the sink node.

The purpose of the learning end determination condition is, for example, to output the correct answer for all predetermined number of input networks. The number of nodes and edges of the input network corresponds to the number of nodes and edges of the training data used in the learning task.

The learning content update procedure instructs, for example, to increase the number of edges when the number of edges of the current input network is less than a given number, and to increase the number of nodes when the number of edges reaches the given number. With the increase in the number of edges or nodes, the computational complexity increases. The initial value of the number of edges for the specified number of nodes is defined in advance.

The validation rule 147 indicates, for example, that the absence of the path between the source node and the sink node in the residual network is the condition of correct answer.

The self-trainer unit 110 repeats learning of the learning model unit 120 and generation of training data along the flow chart shown in FIG. 3, based on the self-training rule 145 and the validation rule 147.

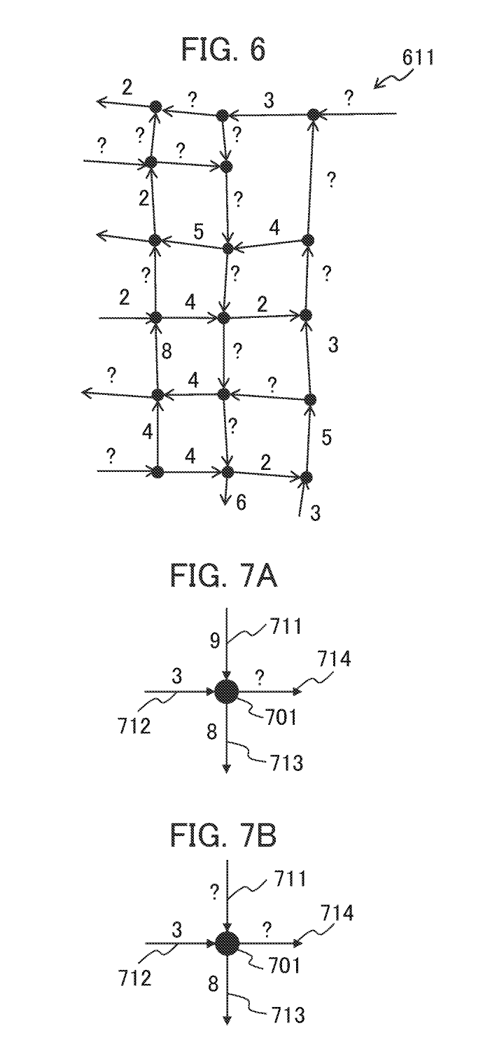

Next, an example of traffic volume estimation problem will be described. FIG. 6 shows an example 611 of input network to the learning model unit 120. The network 611 shows a road network and its traffic volume. Black dotted nodes represent intersections, and edges represent roads. The arrows of edges indicate the traffic direction of roads. All the roads between intersections in the network 611 have one-way traffic.

The numbers of edges represent the traffic volume during a specific period of time in the road. Some data of the traffic volume is missing. The “?” indicates that the data of the traffic volume of the road is not present and unknown. In the case of two way road, the number of edges represents the two-way traffic volume between nodes. The traffic volume of the road is measured, for example, by a measuring device disposed on the road.

The learning model unit 120 estimates all the missing traffic volumes in the input network, and outputs a network that shows the traffic volumes of all the roads. The validation rule 147 uses the flow conservation law. The flow conservation law shows that the sum of inflows in one node is equal to the sum of outflows from the particular node.

FIGS. 7A and 7B show four roads that connect to one intersection to illustrate the flow conservation law. Roads 711 to 714 connect to an intersection 701. The traffic volume of one road is unknown in FIG. 7A, and the traffic volume of two roads is unknown in FIG. 7B.

More specifically, in FIG. 7A, the inflow from the road 711 to the intersection 701 is 9. The inflow from the road 712 to the intersection 701 is 3. The outflow from the intersection 701 to the road 713 is 8. The outflow from the intersection 701 to the road 714 is unknown (“?”). The flow conservation law shows that the outflow to the road 714 is 4.

On the other hand, in FIG. 7B, in addition to the outflow to the road 714, the inflow from the road 711 is also unknown. The flow conservation law shows that a plurality of pairs of flow volumes of the road 714 and the road 711 can be the correct answer. More specifically, arbitrary combinations, in which the sum of the volume of traffic of the road 711 and the volume of traffic to the road 714 is +5, are the correct answer. Note that the inflow to the intersection 701 is represented by a positive value and the outflow from the intersection is represented by a negative value.

In the following, a description will be given of an example of the self-training rule 145 and the validation rule 147 for the traffic volume estimation problem. As described above, the self-training rule 145 establishes the procedure for generating input data of new training data, the learning end determination condition, and the learning content update procedure.

The procedure for generating input data of new training data instructs to generate a given number of graphs with different configurations, for example, from a given number of nodes and from a given number of edges. For example, each edge has either one way (one-way traffic) or has two ways (two-way traffic).

The procedure for generation input data of new training data also instructs to generate a given number of networks of combinations of different traffic volumes. In the network, the procedure instructs to randomly select a given number of edges and determine them as edges with traffic volume unset.

The procedure for generating input data of new training data instructs, with respect to each node, to set the traffic volume to a random number within a given range, for each of all edges excluding edges determined that their traffic volume is not set. However, with respect to the node to which no edge with traffic volume unset is connected, the procedure indicates to repeat assignment with random numbers until the sum of traffic volumes assigned to the set of edges connected to the node meets the flow conservation rule.

In the learning of the other problem described above, the procedure for generating input data of new training data generates training data candidates by using input data different from the input data in the existing training data. In this problem, a plurality of output values considered to be the correct answer can be present for one input object. It may be possible to use a learning model unit with a different parameter set for generating training data of the same learning task. Then, in the generation of new training data candidates, it may be possible to use input data included in the existing training data.

The purpose of the learning end determination condition is, for example, to output the correct answer for all the input networks of a given number. As described above, when the flow rate of a plurality of edges connected to one node is unknown, there are a plurality of correct answers. The numbers of nodes and edges of the input network correspond to the numbers of nodes and edges of the training data that have been used in the learning task.

The learning content update procedure instructs to increase the number of edges when the number of edges of the current input network is less than a given number, and to increase the number of nodes when the number of edges reaches the given number. With the increase in the number of edges or nodes, the computational complexity increases. The initial value of the number of edges for a specific specified number of nodes is defined in advance. The validation rule 147 indicates that the flow conservation rule is satisfied in each node.

The information processing system 1 according to the present embodiment can also be applied to problems other than the three problem examples described above. The validation rules shown for each of the three problem examples are an example and other validation rules are also available.

In the following, a description will be given of an example of the operation of the information processing system 1. A description will be given of an example of the operation of the learning model unit 120 for the maximum flow problem. The learning model unit 120 for the maximum flow problem can be applied to, for example, opening/closing amount control of each valve in a production line, traffic volume control in a city, on-site crowd control, and the like.

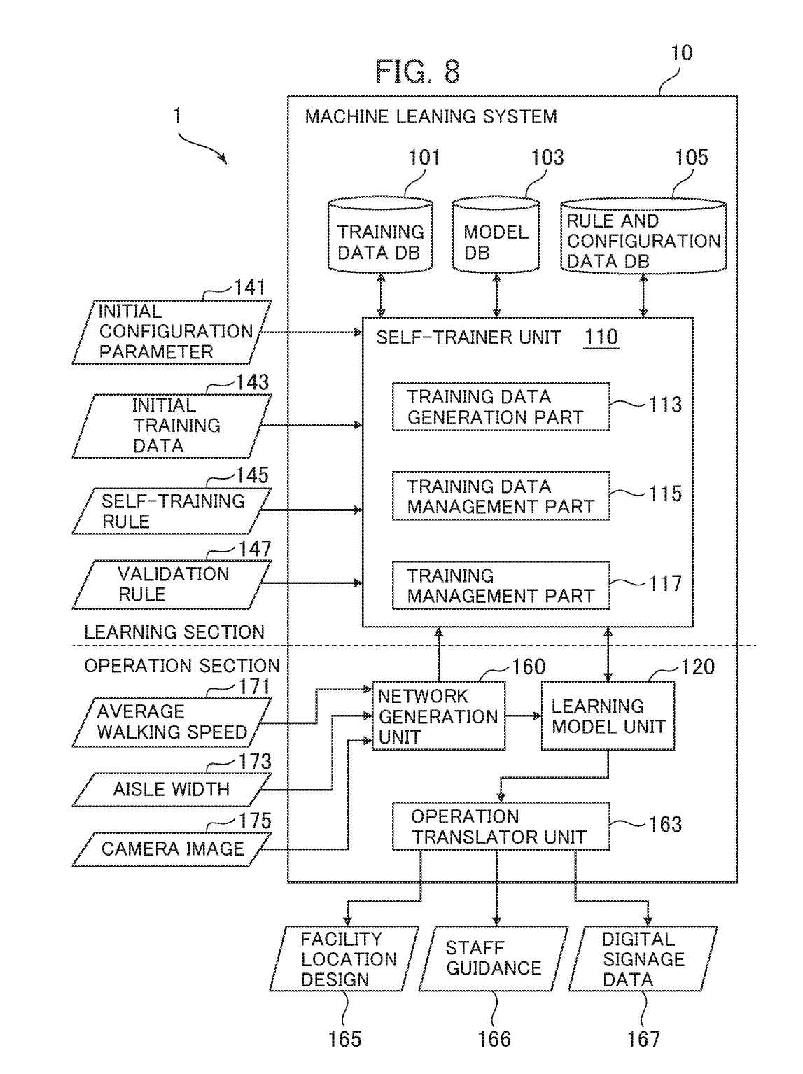

FIG. 8 shows another configuration example of the information processing system 1 applied to on-site crowed control. The information processing system 1 shown in FIG. 8 can guide the flow of people, for example, in a station, by a digital signage according to the congestion state around the ticket gate and on the platform, or can allow users in a commercial facility to effectively use the facility by displaying congestion prediction information on a monitor.

In addition to the configuration shown in FIG. 1, the machine learning system 10 also includes a network generation unit 160 and an operation translator unit 163. These units can be configured, for example, by 210 that operates according to the program.

Basically the information processing system 1 can be divided into a learning part and an operation part. The learning part is a functional part that allows the learning model unit 120 to learn, and the operation part is a functional part that actually performs on-site crowd control.

The network generation part 160 generates a target network from externally input information, for example, an average walking speed 171, an aisle width 173, and a camera image 175. The generated network is input to the learning model unit 120 after learning. The learning model unit 120 calculates the maximum flow. The operation translator unit 163 interprets the calculated maximum flow information, for example, into facility location design 163, staff guidance 166, digital signage data 167, or other relevant information and outputs the information.

The operation of the learning unit is basically as described above. The self-trainer unit 110 can also control relearning of the learning model unit 120, for example, based on the network information which is the current input data. For example, in response to detecting an input of a network whose size is greater than the network in the past learning, the self-trainer unit 110 can start the relearning of the learning model unit 120.

The following shows an example of the evaluation result of the machine learning system 10 according to the present embodiment. The inventors prepared training data (teacher data) with short sequence length (L=5) for the ECHO problem (task) of sequence data. The ECHO problem is the problem of outputting an input sequence as an output sequence. The inventors evaluated whether the machine learning system 10 according to the present embodiment autonomously applies the learning model unit 120 to data with longer sequence length (L=19).

After having allowed the learning model unit 120 to learn with the prepared training data, the machine learning system 10 repeated generation of new training data and relearning of the learning model unit 120 (self-learning of the learning model unit 120). The machine learning system 10 according to the present embodiment was able to autonomously generate the learning model unit 120 that is applied to the data with long sequence length (L=19).

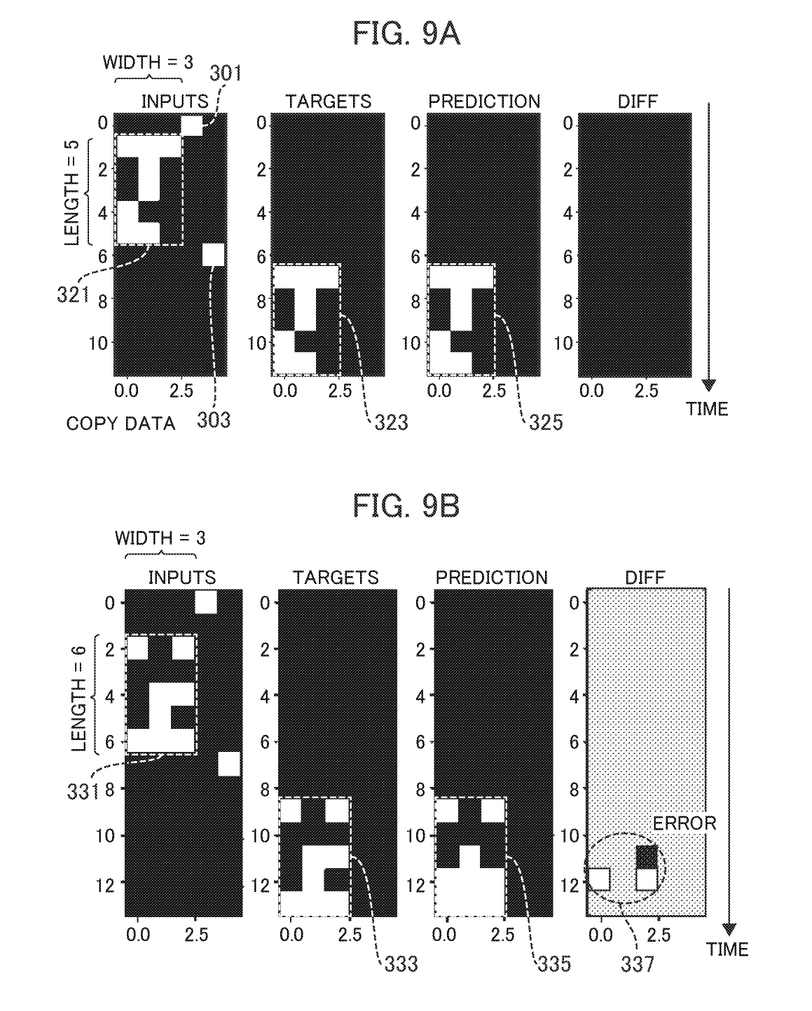

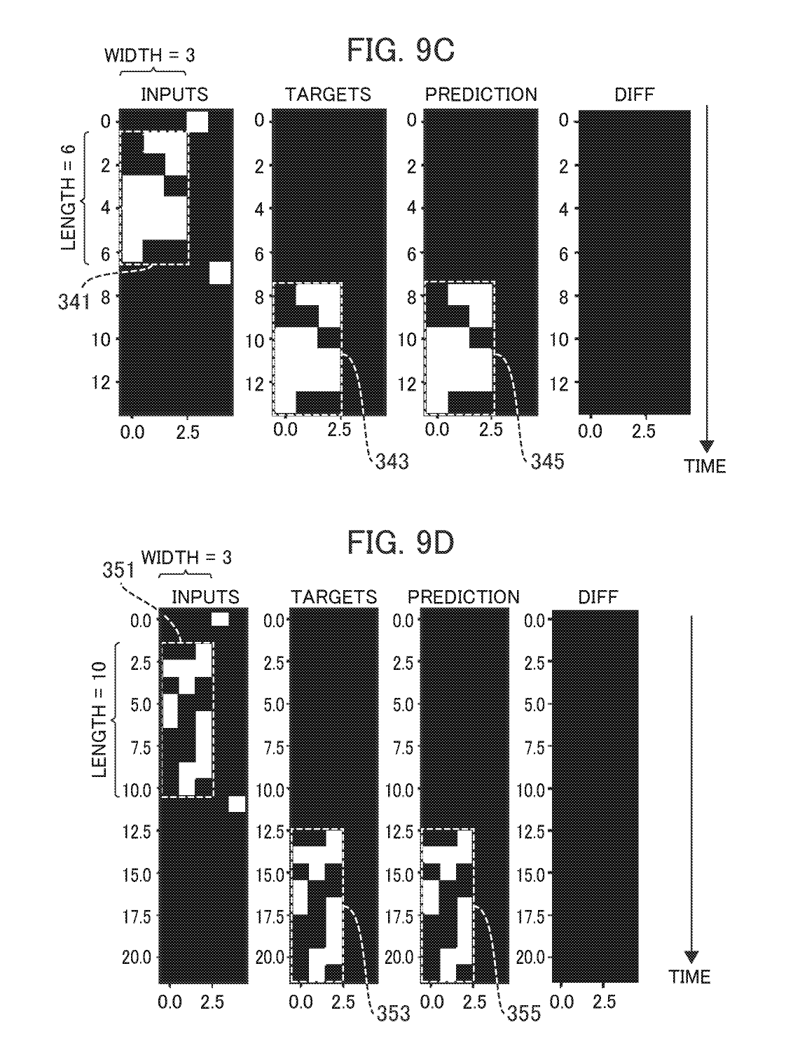

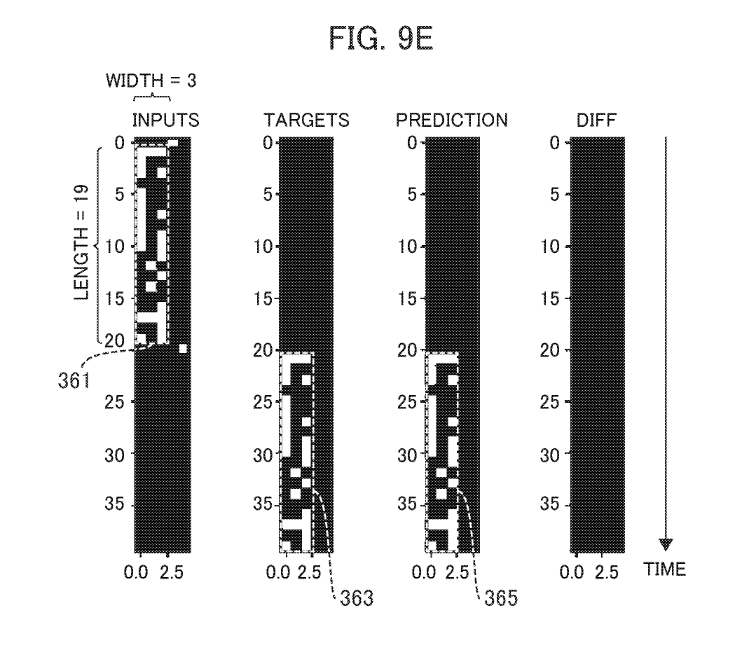

FIGS. 9A to 9E show the evaluation results. FIGS. 9A to 9E respectively show the input value, the target value (true value), the predicted value (output value), and the difference between the target value and the predicted value in the ECHO problem.

FIG. 9A shows the result when the leaning with sequence length 5 is completed. An input value 321 is 0/1 binary data with sequence width 3 and sequence length 5. A start flag 301 and an end flag 303 are attached to the input value 321. A predicted value 325 output from the learning model unit 120 corresponds to a target value 323 and their difference is zero.

FIG. 9B shows the intermediate result of the learning with sequence length 6. A predictive value 335 that the learning model unit 120 output for the input value is different from a target value 333. There is a difference 337 between the predicted value 335 and the target value 333. FIG. 9C shows the result when the learning with sequence length 6 is completed. A predicted value 345 for an input value 341 output from the learning model unit 120 corresponds to a target value 343 and their difference is zero.

FIG. 9D shows the result when learning with sequence length 10 is completed. A predictive value 355 that the learning model unit 120 output for an input value 351 corresponds to a target value 353 and their difference is zero. FIG. 9E shows the result when the learning with sequence length 19 is completed. A predicted value 365 that the learning model unit 120 output for an input value 361 corresponds to a target value 363 and their difference is zero.

As described above, the machine learning system 10 according to the present embodiment was able to autonomously achieve leaning for more complex data from short sequence data (L=5) input from the outside.

It should be noted that the present invention is not limited to the above exemplary embodiment and includes various variations. For example, the above embodiment has been described in detail in order to better illustrate the invention, and does not necessarily include all the described configurations. Further, part of the configuration of an embodiment can be replaced with the configuration of another embodiment, and the configuration of an embodiment can be added to the configuration of another embodiment. Further, the addition, deletion, or replacement of the configuration of another embodiment is possible with respect to part of the configuration of each embodiment.

Further, some or all of the configurations, functions, process units, and the like may be achieved in hardware, for example, by a design with an integrated circuit. Further, each of the configurations, functions, and the like described above may be achieved by software in such a way that the processor interprets and executes programs that achieve each of the functions. Information such as programs, tables, and files for realizing each of the functions can be placed in a storage device such as a memory, a hard disk, or SSD (Solid State Drive), or placed in a storage medium such as an IC card or SD card.

Further, the control and information lines that would be necessary for explanation are shown here and not all control and information lines are necessarily expressed in terms of product. In practice, almost all of the configurations can be considered to be connected to each other.

### LIST OF REFERENCE SIGNS

1: information processing system, 10: machine learning system, 110: self-trainer unit, 120: learning model unit, 113: training data generation part, 115: training data management part, 117: training management part, 141: initial configuration parameter, 145: self-training rule, 147: validation rule, 210: processor, 220: memory, 230: auxiliary storage, 240: input/output interface, 242: input device, 244: display device, 451: procedure for generating input data, 453: leaning content update procedure, 452: learning end determination condition

1. An information processing system comprising:
a learning model unit;
a trainer unit for allowing the learning model unit to learn; and
a storage unit,
wherein the storage unit stores a validation rule defined in advance that indicates a condition determining that an output value of the learning model unit for an input value is determined to be true, and
wherein the trainer unit includes:
inputting a plurality of first input values to the learning model unit;
obtaining a plurality of first output values of the learning model unit for the plurality of first input values;
determining whether each of the first output values is true for each of the first input values by referring to the validation rule; and
storing a pair of a first output value, which is determined to be true in the plurality of first output values, and the corresponding first input value into the storage unit, as new training data for supervised learning.

2. The information processing system according to claim 1,
wherein the trainer unit allows the learning model unit to learn by using the new training data.

3. The information processing system according to claim 2,
wherein the trainer unit generates the new training data by inputting the plurality of first input values to the learning model unit after learning with initial training data.

4. The information processing system according to claim 3,
wherein after allowing the learning model unit to learn by using the initial training data input from the outside, the trainer unit inputs the plurality of first input values to the learning model unit.

5. The information processing system according to claim 3,
wherein the first input values are the data for learning with computational complexity higher than that of the initial training data.

6. The information processing system according to claim 3,
wherein the trainer unit includes:
after learning of the learning model unit by using the new training data, inputting a plurality of second input values to the learning model unit to obtain a plurality of second output values;
determining whether each of the plurality of second output values is true for each of the plurality of second input values by referring to the validation rule; and
using a pair of a second output value, which is determined to be true in the plurality of second output values, and the corresponding second input value, as training data for the relearning of the learning mode unit.

7. The information processing system according to claim 6,
wherein the trainer unit includes:
inputting test data to the learning model unit after learning of the learning model unit by using the new training data;
determining an accuracy rate to the test data based on the validation rule;
determining whether or not to continue the learning of the current learning content of the learning model based on the accuracy rate and on a determination condition defined in advance; and
when determining to end the learning of the current learning content, obtaining the second output values by inputting the plurality of second input values to the learning model unit.

8. The information processing system according to claim 7,
wherein the plurality of second input values are the data for learning with computational complexity higher than that of the plurality of first input values.

9. A method performed in an information processing system including a learning model unit, a trainer unit for allowing the learning model unit to learn, and a storage unit,
wherein the storage unit stores a validation rule defined in advance that indicates a condition determining that an output value of the learning model for an input value is true, and
wherein the method, by the trainer unit, comprises:
inputting a plurality of input values to the learning model unit;
obtaining a plurality of output values of the learning model unit for the plurality of input values;
determining whether each of the output values is true for each of the input values by referring to the validation rule; and
storing a pair of an output value, which is determined to be true in the plurality of output values, and the corresponding input value into the storage unit, as new training data for supervised learning.
